(19) United States
(12) Patent Application Publication
(10) Pub. No.: US 2018/0294498 A1
(43) Pub. Date: Oct. 11, 2018

(54) CONTROL METHOD AND SYSTEM FOR STOP MODE OF FUEL CELL

(71) Applicants: HYUNDAI MOTOR COMPANY, Seoul (KR); KIA MOTORS CORPORATION, Seoul (KR)

(72) Inventor: Kyung Won SUH, Seoul (KR)

(21) Appl. No.: 15/820,901

(22) Filed: Nov. 22, 2017

(30) Foreign Application Priority Data
Apr. 11, 2017 (KR) 10-2017-0046478

(51) Int. Cl. H01M 8/04955; H01M 8/04303; H01M 8/04537; H01M 8/04858; H01M 8/04992; H01M 8/04664

(52) U.S. Cl. CPC H01M 8/04955; H01M 8/04303; H01M 8/04544; H01M 2250/10; H01M 8/04992; H01M 8/04664; H01M 2250/20; H01M 8/04865

(57) ABSTRACT

The present invention relates to a method and system for controlling a stop mode of a fuel cell. In particular, the present invention provides a method and system for controlling a stop mode of a fuel cell which are characterized by calculating the degree of deterioration of a fuel cell, determining a stopping voltage in accordance with the calculated degree of deterioration, and controlling an output voltage of the fuel cell to be the determined stopping voltage.

### CROSS REFERENCE TO RELATED APPLICATION

The present application claims priority to Korean Patent Application No. 10-2017-0046478, filed on Apr. 11, 2017, the entire contents of which is incorporated herein for all purposes by this reference.

### BACKGROUND OF THE INVENTION

### Field of the Invention

The present invention relates to a control method and system for a stop mode of a fuel cell, the method and system being able to improve durability and operability by varying a stopping voltage in a stop mode of a fuel cell in accordance with the degree of deterioration of the fuel cell.

### Description of the Related Art

The description provided above as a related art of the present invention is only for helping understanding the background of the present invention and should not be construed as being included in the related art known by those skilled in the art.

A fuel cell, which is a kind of device that converts chemical energy from a fuel into electrical energy through an electrochemical reaction in a fuel cell stack without changing the chemical energy into heat by burning the fuel, can be used not only for supplying power for industry, homes, and vehicles, but for supplying power for small-sized electrical/electronic products, particularly, mobile devices.

When a fuel cell is stopped or required power is a predetermined value or less, it is required to stop supplying a reactive gas to the fuel cell, but the fuel cell outputs power by reaction of the gases remaining in a reaction layer, so the electrodes of the fuel cell are exposed to high potential.

However, when an electrode, particularly, the platinum (Pt) catalyst at the cathode, is exposed to high potential close to OCV (Open Circuit Voltage), the catalyst oxidizes by reacting with the oxygen in the supplied air or the moisture in humid air. The oxidized catalyst does not react in the fuel cell, so the performance of the fuel cell is deteriorated and it causes an output drop of the fuel cell when the fuel cell is operated with the current in this case, which results in reduction of system efficiency.

an upper limit voltage lower than the OCV and controls a fuel cell under the upper limit voltage in a stop mode to prevent reduction in performance of electrodes at high potential has been published in the art.

However, setting an upper limit voltage is not enough to compensate for the deterioration and catalyst separation is caused by the deterioration, which causes permanent deterioration of the performance.

The foregoing is intended merely to aid in the understanding of the background of the present invention, and is not intended to mean that the present invention falls within the purview of the related art that is already known to those skilled in the art.

### SUMMARY OF THE INVENTION

The present invention has been made in an effort to solve the problems and an object of the present invention is to provide a method and system for controlling a fuel cell to maintain a stopping voltage that is determined on the basis of the degree of deterioration of an electrode.

In order to achieve the above object, according to an aspect of the present invention, there is provided a method of controlling a stop mode of a fuel cell, the method including: calculating a degree of deterioration of the fuel cell; determining a stopping voltage of the fuel cell in accordance with the calculated degree of deterioration; determining whether the fuel cell has entered the stop mode; and controlling an output voltage of the fuel cell to be the determined stopping voltage when it is determined that the fuel cell has entered the stop mode.

In the calculating of a degree of deterioration, the degree of oxidization of the fuel cell may be calculated using a degree of deterioration of a cathode catalyst of the fuel cell.

In the calculating of a degree of deterioration, the degree of oxidization of the cathode catalyst of the fuel cell may be updated and stored in a nonvolatile memory.

The degree of oxidization of the cathode catalyst may be estimated from the following equations in the determining of a degree of deterioration.

$$\frac{d {θ}_{PtOx}}{dt} = {k}_{PtOx} ( ( 1 - {θ}_{PtOx} ) exp ( \frac{{α}_{a}^{′} F}{RT} {η}_{PtOx} ) - {θ}_{PtOx} exp ( \frac{- {α}_{c}^{′} F}{RT} {η}_{PtOx} ) )$$

$${η}_{PtOx} = {Φ}_{C} - {Φ}_{ion} - {U}_{PtOx}$$

θ_{PtOx}: degree of oxidization of cathode platinum catalyst (0˜1)

η_{PtOx}: potential difference at cathode

k_{PtOx}: reaction rate for PtOx formation

α′_{α}, α′_{c}: anodic and cathodic transfer coefficient for PtOx formation

U_{PtOx}: PtOx equilibrium potential

ϕ_{C}: measured voltage of cell of fuel cell (average for a plurality of cells)

ϕᵢₒₙ: potential loss of electrolytic membrane

U_{PtOx}: equilibrium voltage

F: Faraday constant

R: ideal gas constant

T: temperature (K)

In the determining of a stopping voltage, the calculated degree of deterioration may be compared with a predetermined value, and one of a plurality of stopping voltages stored in advance may be selected in accordance with the comparison result.

In the determining of a stopping voltage, the stopping voltage may be determined such that the larger the calculated degree of deterioration, the lower the stopping voltage.

In the determining of a stopping voltage, the stopping voltage may be determined such that the smaller the calculated degree of deterioration, the higher the stopping voltage.

In the determining of whether the fuel cell has entered the stop mode, whether the stop mode has been entered may be determined in accordance with whether requested output exists.

In order to achieve the above object, according to another aspect of the present invention, there is provided a system for controlling a stop mode of a fuel cell, the system including: a deterioration calculating unit calculating a degree of deterioration of a fuel cell; a stopping voltage determining unit determining a stopping voltage of the fuel cell on the basis of the degree of deterioration of the fuel cell calculated by the deterioration calculating unit; a stop mode entrance determining unit determining whether the fuel cell has entered the stop mode; and a power distribution control unit controlling an output voltage of the fuel cell to be the stopping voltage determined by the stopping voltage determining unit when the stop mode entrance determining unit determines that the fuel cell has entered the stop mode.

The system may further include an oxidization estimating unit estimating a degree of oxidization of a cathode catalyst of the fuel cell, in which the deterioration calculating unit may calculate the degree of deterioration of the fuel cell from the degree of oxidization of the cathode catalyst of the fuel cell estimated by the oxidization estimating unit.

The oxidization estimating unit may include a nonvolatile memory for updating and storing the degree of oxidization of the cathode catalyst.

Further, a reference deterioration degree and a plurality of stopping voltages may be stored in advance in the stopping voltage determining unit, and the stopping voltage determining unit may determine the stopping voltage by comparing the degree of oxidization of the fuel cell calculated by the deterioration calculating unit with the reference deterioration degree and selecting one of the stopping voltages stored in advance in accordance with the comparing result.

The stopping voltage determining unit may determine the stopping voltage such that the larger the degree of deterioration calculated by the deterioration calculating unit, the lower the stopping voltage, and may determine the stopping voltage such that the smaller the calculated degree of deterioration, the higher the stopping voltage.

According to the method and system for varying a stopping voltage in a stop mode of a fuel cell, the following effects can be achieved.

First, it is possible to prevent a performance drop by preventing deterioration of a fuel cell that may be caused during operation.

Second, it is possible to achieve an effect of improving durability which reduces a possibility of causing a permanent performance drop that cannot be restored due to separation from an electrode of a cathode platinum (Pt) catalyst when the catalyst is continuously exposed to high voltage by minimizing oxidization of the catalyst during operation.

Third, the system efficiency is increased by compensating for the deterioration while the fuel cell is operated, so it is possible to improve the fuel efficiency of a vehicle, as compared with the related art.

Fourth, since the stopping voltage of the fuel cell is selectively dropped only when it is required, it is possible to minimize a delay of output when stopping the stop mode.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 shows a flowchart of a process flow of an embodiment of the present application;

FIG. 2 shows a flowchart illustrating a method of controlling a stop mode of a fuel cell according to an embodiment of the present invention;

FIG. 3 shows a diagram illustrating the configuration of a system for controlling a stop mode of a fuel cell according to an embodiment of the present invention; and

FIG. 4 shows a diagram illustrating the configuration of a system for controlling a stop mode of a fuel cell according to another embodiment of the present invention.

### DETAILED DESCRIPTION OF THE INVENTION

Although the present invention was described with reference to specific embodiments shown in the drawings, it is apparent to those skilled in the art that the present invention may be changed and modified in various ways without departing from the scope of the present invention, which is described in the following claims.

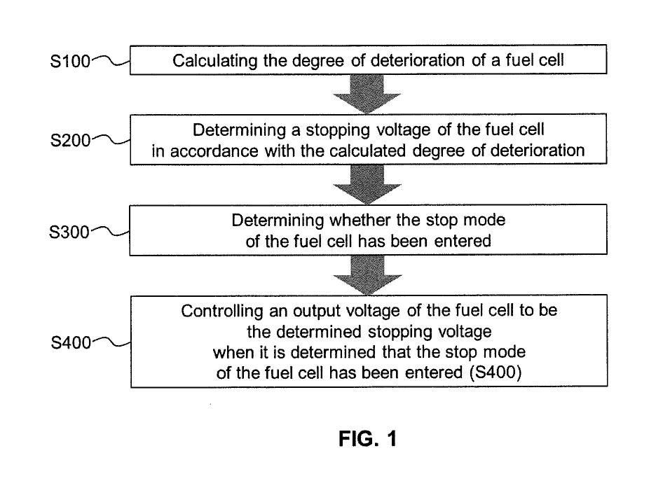

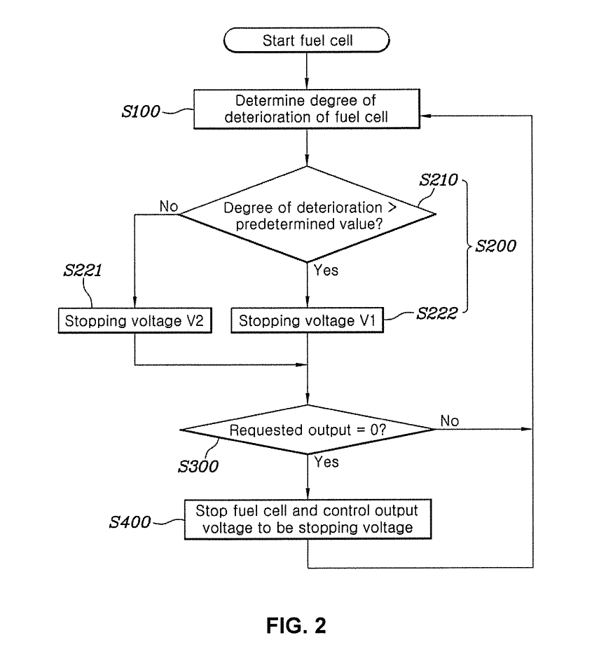

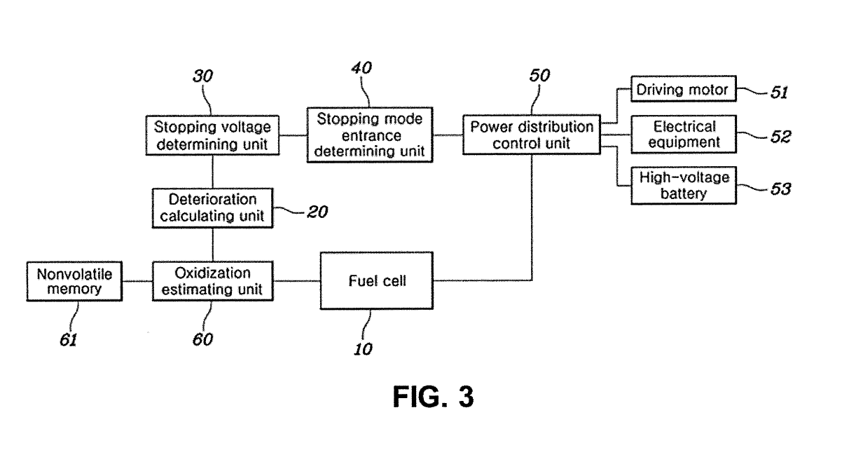

Hereinafter, exemplary embodiments of the present invention will be described in detail with reference to the accompanying drawings. FIGS. 1 and 2 show flowcharts illustrating methods of controlling a stop mode of a fuel cell 10 according to an embodiment of the present invention. FIG. 3 shows a diagram illustrating the configuration of a system for controlling a stop mode of a fuel cell 10 according to an embodiment of the present invention.

Referring to FIG. 2, a method of controlling a stop mode of a fuel cell 10 according to an embodiment of the present invention includes: calculating the degree of deterioration of a fuel cell 10 (S100); determining a stopping voltage of the fuel cell 10 in accordance with the calculated degree of deterioration (S200); determining whether the stop mode of the fuel cell has been entered (S300); and controlling an output voltage of the fuel cell 10 to be the determined stopping voltage when it is determined that the stop mode of the fuel cell 10 has been entered (S400).

According to the method of controlling a stop mode of a fuel cell 10, the stopping voltage is determined on the basis of the calculated degree of deterioration, in which when the degree of deterioration is large, compensation of the deterioration is promoted, and when the degree of deterioration is small, the stopping voltage is determined such that an output delay is minimized when the stopping mode of the fuel cell 10 is stopped. Accordingly, it is possible to both increase the efficiency of a system and minimize the output delay.

Referring to FIG. 3, a system for controlling a stop mode of a fuel cell 10 according to an embodiment of the present invention includes: a deterioration calculating unit 20 that calculates the degree of deterioration of a fuel cell 10; a stopping voltage determining unit 30 that determines a stopping voltage of the fuel cell on the basis of the degree of deterioration of the fuel cell 10 calculated by the deterioration calculating unit 20; a stop mode entrance determining unit 40 that determines whether the fuel cell 10 has entered the stop mode; and a power distribution control unit 50 that controls an output voltage of the fuel cell 10 to be the stopping voltage determined by the stopping voltage determining unit 30 when the stop mode entrance determining unit determines that the fuel cell 10 has entered the stop mode.

Further, the method of controlling a stop mode of a fuel cell 10 according to an embodiment of the present invention shown in FIG. 2 can be accomplished by the system for controlling a stop mode of a fuel cell 10 shown in FIG. 3.

Accordingly, referring to FIGS. 2 and 3, the calculating of the degree of deterioration of a fuel cell (S100) is a step in which the deterioration calculating unit 20 calculates the degree of deterioration of the fuel cell 10.

An oxidization estimating unit 60 estimates the degree of oxidization of platinum (Pt) that is a cathode catalyst of the fuel cell 10 and it is possible to calculate the degree of deterioration of the fuel cell 10 from the degree of oxidization of the catalyst estimated by the deterioration estimating unit 60. The degree of deterioration of the fuel cell 10 may be obtained by scaling the degree of oxidization of the cathode catalyst or may be obtained from an equation employing the degree of oxidization of the cathode catalyst as a variable.

The degree of oxidization of the cathode catalyst of the fuel cell 10 estimated by the oxidization estimating unit 60 can be updated and stored in a nonvolatile memory 61 to store the newest oxidization degree value.

In the calculating of the degree of deterioration, the degree of oxidization of the cathode catalyst can be obtained from the following equation. In the following equation, the Faraday constant can be 96485, the ideal gas constant can be 8.314, and k_{PtOx}, α′_{α}, α′_{c}, and U_{PtOx} that are properties based on the material and configuration of an electrode can be calculated from test results on the material or other documents. Further, a membrane potential loss can be obtained by multiplying the current of a fuel cell 10 by predetermined calculated or estimated membrane resistance.

$$\frac{d {θ}_{PtOx}}{dt} = {k}_{PtOx} ( ( 1 - {θ}_{PtOx} ) exp ( \frac{{α}_{a}^{′} F}{RT} {η}_{PtOx} ) - {θ}_{PtOx} exp ( \frac{- {α}_{c}^{′} F}{RT} {η}_{PtOx} ) )$$

$${η}_{PtOx} = {Φ}_{C} - {Φ}_{ion} - {U}_{PtOx}$$

θ_{PtOx}: degree of oxidization of cathode platinum catalyst (0˜1)

η_{PtOx}: potential difference at cathode

k_{PtOx}: reaction rate for PtOx formation

α′_{α}, α′_{c}: anodic and cathodic transfer coefficient for PtOx formation

U_{PtOx}: PtOx equilibrium potential

ϕ_{C}: measured voltage of cell of fuel cell (average for a plurality of cells)

ϕᵢₒₙ: potential loss of electrolytic membrane

U_{PtOx}: equilibrium voltage

F: Faraday constant

R: ideal gas constant

T: temperature (K)

The above equations can be more clearly obtained by referring to the theses described above in ‘Non-patent documents’.

Further, a previously calculated value is required to calculate the degree of oxidization of the electrode catalyst. The previously calculated value is used when the fuel cell 10 is in operation, and it may be calculated from the values stored in the nonvolatile memory 61 when there is no previously calculated value, for example, right after the fuel cell 10 is operated.

In detail, when the fuel cell 10 is initially operated, a new degree of oxidization of the electrode catalyst is calculated under the assumption that the voltage of the fuel cell 10 is 0[V] for a stop time by reading out the degree of oxidization of the electrode catalyst stored in the nonvolatile memory 61 and measuring the stop time from the stop to the start of the fuel cell 10.

The determining of a stopping voltage in accordance with the degree of deterioration (S200) can determine the stopping voltage by comparing the degree of oxidization calculated by the stopping voltage determining unit 30 with a predetermined value and selecting one of a plurality of stopping voltages stored in advance in accordance with the comparing result.

A reference deterioration degree and a plurality of stopping voltages are stored in advance in the stopping voltage determining unit 30, and the stopping voltage determining unit 30 can determine the stopping voltage by comparing the degree of oxidization of the fuel cell 10 calculated by the deterioration calculating unit with the reference deterioration degree and selecting one of the stopping voltages stored in advance in accordance with the comparing result.

For example, the calculated degree of deterioration can be compared with a predetermined value (S210), the stopping voltage can be determined as V1 when the degree of deterioration is larger than the predetermined value (S222), and the stopping voltage may be determined as V2 when the degree of deterioration is equal to or smaller than the predetermined value (S221). V2 is set larger than V1.

It is possible to quickly compensate the deterioration by determining the stopping voltage such that the larger the calculated degree of deterioration, the smaller the stopping voltage.

In contrast, it is possible to minimize a delay of compensation for output when the stop mode of the fuel cell 10 is stopped by determining the stopping voltage such that the smaller the calculated degree of deterioration, the larger the stopping voltage.

The determining of whether a stop mode of the fuel cell 10 has been entered (S300) can be performed by the stop mode entrance determining unit 40.

It is possible to determine whether the fuel cell 10 has entered the stop mode, depending on whether requested output exists. When the requested output of the fuel cell 10 is 0 (S300), there is no need to operate the fuel cell 10 anymore, so the stop mode is entered, but when the requested output is not 0, the process can return to the determining of the degree of deterioration (S100).

When the fuel cell 10 has entered the stop mode, the operation of the fuel cell 10 is stopped and the controlling of an output voltage of the fuel cell 10 to be the determined stopping voltage (S400) can be performed by the power distribution control unit 50.

The power distribution control unit 50 may control the fuel cell 10, and a DC-DC converter (not shown) existing among a driving motor 51, electrical equipment 52, and a high-voltage battery 53.

In detail, when the output voltage of the fuel cell 10 is higher than the stopping voltage with the operation of the fuel cell 10 stopped, the DC-DC converter (not shown) is controlled to maintain the output voltage of the fuel cell 10 is maintained at the determined stopping voltage by distributing power to the electrical equipment 52 or the high-voltage battery 53.

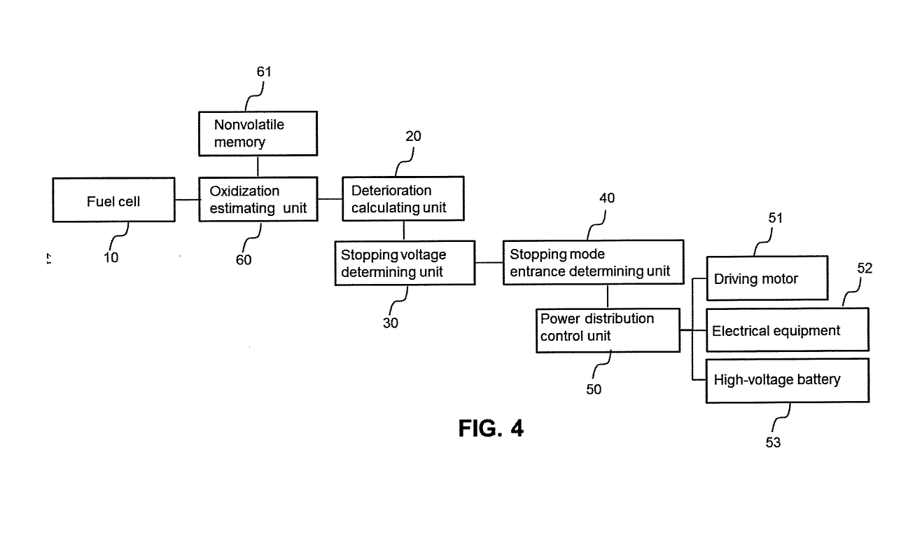

Referring to FIG. 4, a system for controlling a stop mode of a fuel cell 10 according to another embodiment of the present invention includes: a deterioration calculating unit 20 that calculates the degree of deterioration of a fuel cell 10; a stopping voltage determining unit 30 that determines a stopping voltage of the fuel cell 10 on the basis of the degree of deterioration of the fuel cell 10 calculated by the deterioration calculating unit 20; a stop mode entrance determining unit 40 that determines whether the fuel cell 10 has entered the stop mode; and a power distribution control unit 50 that controls an output voltage of the fuel cell 10 to be the stopping voltage determined by the stopping voltage determining unit 30 when the stop mode entrance determining unit determines that the fuel cell 10 has entered the stop mode. In this embodiment, the fuel cell 10 is not directly connected to the power distribution control unit 50.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of controlling a stop mode of a fuel cell, the method comprising:
calculating a degree of deterioration of the fuel cell;
determining a stopping voltage of the fuel cell in accordance with the calculated degree of deterioration;
determining whether the fuel cell has entered the stop mode; and
controlling an output voltage of the fuel cell to be the determined stopping voltage when it is determined that the fuel cell has entered the stop mode.

2. The method of claim 1, wherein in the calculating of a degree of deterioration, the degree of deterioration of the fuel cell is calculated using a degree of oxidization of a cathode catalyst of the fuel cell.

3. The method of claim 2, wherein in the calculating of a degree of deterioration, the degree of oxidization of the cathode catalyst of the fuel cell is updated and stored in a nonvolatile memory.

4. The method of claim 2, wherein the degree of oxidization of the cathode catalyst is estimated from the following equations in the determining of a degree of deterioration,
$$\frac{d {θ}_{PtOx}}{dt} = {k}_{PtOx} ( ( 1 - {θ}_{PtOx} ) exp ( \frac{{α}_{a}^{′} F}{RT} {η}_{PtOx} ) - {θ}_{PtOx} exp ( \frac{- {α}_{c}^{′} F}{RT} {η}_{PtOx} ) )$$
$${η}_{PtOx} = {Φ}_{C} - {Φ}_{ion} - {U}_{PtOx}$$
θ_{PtOx}: degree of oxidization of cathode platinum catalyst (0˜1)
η_{PtOx}: potential difference at cathode
k_{PtOx}: reaction rate for PtOx formation
α′_{α}, α′_{c}: anodic and cathodic transfer coefficient for PtOx formation
U_{PtOx}: PtOx equilibrium potential
ϕ_{C}: measured voltage of cell of fuel cell (average for a plurality of cells)
ϕᵢₒₙ: potential loss of electrolytic membrane
U_{PtOx}: equilibrium voltage
F: Faraday constant
R: ideal gas constant
T: temperature (K)

5. The method of claim 1, wherein in the determining of a stopping voltage, the calculated degree of deterioration is compared with a predetermined value and one of a plurality of stopping voltages stored in advance is selected in accordance with the comparing result.

6. The method of claim 1, wherein in the determining of a stopping voltage, the stopping voltage is determined such that the larger the calculated degree of deterioration, the lower the stopping voltage.

7. The method of claim 1, wherein in the determining of a stopping voltage, the stopping voltage is determined such that the smaller the calculated degree of deterioration, the higher the stopping voltage.

8. The method of claim 1, wherein in the determining of whether the fuel cell has entered the stop mode, whether the stop mode has been entered is determined in accordance with whether requested output exists.

9. A system for controlling a stop mode of a fuel cell, comprising:
a deterioration calculating unit calculating a degree of deterioration of a fuel cell;
a stopping voltage determining unit determining a stopping voltage of the fuel cell on the basis of the degree of deterioration of the fuel cell calculated by the deterioration calculating unit;
a stop mode entrance determining unit determining whether the fuel cell has entered the stop mode; and
a power distribution control unit controlling an output voltage of the fuel cell to be the stopping voltage determined by the stopping voltage determining unit when the stop mode entrance determining unit determines that the fuel cell has entered the stop mode.

10. The system of claim 9, further comprising an oxidization estimating unit estimating a degree of oxidization of a cathode catalyst of the fuel cell,
wherein the deterioration calculating unit calculates the degree of deterioration of the fuel cell from the degree of oxidization of the cathode catalyst of the fuel cell estimated by the oxidization estimating unit.

11. The system of claim 10, wherein the oxidization estimating unit includes a nonvolatile memory for updating and storing the degree of oxidization of the cathode catalyst.

12. The system of claim 9, wherein a reference deterioration degree and a plurality of stopping voltages are stored in advance in the stopping voltage determining unit, and the stopping voltage determining unit determines the stopping voltage by comparing the degree of oxidization of the fuel cell calculated by the deterioration calculating unit with the reference deterioration degree and selecting one of the stopping voltages stored in advance in accordance with the comparing result.

13. The system of claim 9, wherein the stopping voltage determining unit determines the stopping voltage such that the larger the degree of deterioration calculated by the deterioration calculating unit, the lower the stopping voltage, and determines the stopping voltage such that the smaller the calculated degree of deterioration, the higher the stopping voltage.
